(19) United States
(12) Patent Application Publication
(10) Pub. No.: US 2008/0041115 A1
(43) Pub. Date: Feb. 21, 2008

(54) Washing machine and method of calculating amount of laundry

(75) Inventors: Naoki Kanazawa, Minoosi (JP); Soiichiro Suzuki, Minoosi (JP); Shoichi Matsui, Minoosi (JP); Sadayuki Sato, Minoosi (JP)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/878,236

(22) Filed: Jul. 23, 2007

(30) Foreign Application Priority Data
Aug. 21, 2006 (JP) 2006-224117

(51) Int. Cl. D06F 23/00; D06F 37/30; G01P 15/00

(52) U.S. Cl. 68/12.04; 68/12.01; 73/514.02

(57) ABSTRACT

Provided are a washing machine and a method of calculating the amount of laundry. The washing machine includes a spin basket which has an inner space to put laundry therein and is rotatably mounted about a rotation shaft in a rotational direction by driving a motor and includes: a rotation time calculating unit which calculates a time period when the spin basket rotates once; a pulse torque generating unit which supplies a predetermined current or voltage to the motor during the time period when the spin basket rotates once and generates a pulse torque through an output shaft from the motor; an acceleration measuring unit which measures rotation acceleration of the output shaft of the motor according to the pulse torque generated from the motor; and a weight calculating unit which calculates the weight of the laundry put in the inner space of the spin basket by the rotation acceleration.

### CROSS-REFERENCE TO RELATED APPLICATIONS

This application claims the benefit of Japanese Patent Application No. 2006-224117, filed on Aug. 21, 2006 in the Japanese Intellectual Property Office, the disclosure of which is incorporated herein by reference.

### BACKGROUND

1. Field

The present invention relates to a washing machine including a laundry amount calculating unit calculating the amount (weight), of laundry put in the inner space of a spin basket and a method of calculating the amount of laundry.

2. Description of the Related Art

Conventionally, a washing machine including a laundry amount calculating unit measuring the weight of laundry put in the inner space of a spin basket is disclosed in Japanese Unexamined Patent Application Publication Nos. 2002-336593, 2004-267334 and Japanese examined Patent Application Publication No. 07-90077.

In such washing machines, torque is applied to a motor at a predetermined period to directly or indirectly measure the moment of inertia of the spin basket and the amount of the laundry is calculated using the second law of motion (torque=moment of inertia×acceleration). The amount of water in a washing process is set by the calculated amount of the laundry.

In the conventional washing machine, the laundry is unevenly distributed in the inner space of the spin basket and thus an imbalance occurs. When the imbalance occurs, the rotation speed of the spin basket periodically varies depending on the variation of the position of the imbalance in a circumferential direction. Accordingly, the moment of inertia is measured in a short time and error increases. As a result, conventionally, the influence due to the imbalance is minimized by measuring the moment of inertia over a long time.

However, when the torque is applied to the motor and the moment of inertia is measured over a long time, the rotation speed of the motor (the rotation speed of the spin basket) significantly varies and thus physical influences, such as windage upon high-speed rotation, frictional resistance of a bearing, contact friction of laundry and mechanical vibrations, and electrical influence, such as a rotation speed detecting error and a variation in power supply voltage, have influence on the calculation of the amount of the laundry. Thus, the amount of the laundry cannot be accurately calculated.

Conventionally, in order to suppress these influences, the measurement over a long time is performed several times and the amount of the laundry is calculated by the average of the measured values. Accordingly, it takes much time to calculate the amount of the laundry so that it is impossible to calculate the amount of the laundry quickly.

### SUMMARY

Therefore, it is an aspect of the present invention to provide a washing machine and a method of calculating the amount of laundry, which are capable of accurately measuring the amount of the laundry put in the inner space of a spin basket in a significantly short time.

Additional aspects and/or advantages of the invention will be set forth in part in the description which follows and, in part, will be apparent from the description, or may be learned by practice of the invention.

The above and/or other aspects can be achieved by providing of a washing machine comprising a rotation shaft comprising an output shaft; a motor; a spin basket which has an inner space to put laundry therein and is rotatably mounted about the rotation shaft in a rotational direction by driving a motor, comprising: a rotation time calculating unit which calculates a time period for the spin basket to rotate once; a pulse torque generating unit which supplies a predetermined current or voltage to the motor during the time period when the spin basket rotates once and generates a pulse torque through the output shaft of the motor; an acceleration calculating unit which calculates rotation acceleration of the output shaft of the motor according to the pulse torque generated from the motor; and a weight calculating unit which calculates the weight of the laundry put in the inner space of the spin basket by the calculated rotation acceleration.

In the washing machine having the above-described configuration, the rotation time calculating unit calculates the amount of time for the spin basket to rotate once, and the pulse torque generating unit supplies the predetermined current or voltage to the motor during the time period when the spin basket rotates once and generates the pulse torque through the output shaft from the motor. The acceleration calculating unit calculates rotation acceleration of the output shaft of the motor according to the pulse torque generated from the motor and the weight calculating unit calculates the moment of inertia by the rotation acceleration and the amount of the laundry. The measured velocity varies for the spin basket rotation and the rotation time, that is the acceleration is that velocity divided by the time, and the weight calculating unit calculates the amount of the laundry by the moment of inertia calculated by the second law of motion (torque=moment of inertia×acceleration).

The period of the speed variation when imbalance occurs in the spin basket is equal to the time period when the spin basket rotates once. Accordingly, it is possible to suppress influence due to the imbalance by measuring the moment of inertia during the time period when the spin basket rotates once.

Since the amount of the laundry can be accurately calculated in a short time period over which the spin basket rotates once, it is possible to accurately calculate the amount of the laundry without physical influences, such as windage upon high-speed rotation, frictional resistance of a bearing, contact friction of laundry and mechanical vibrations, and electrical influence, such as a rotation speed detecting error and a variation in power supply voltage.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view showing the configuration of a washing machine according to an embodiment of the present invention;

FIG. 2 is a block diagram showing a laundry amount calculating unit provided in the washing machine shown in FIG. 1;

FIG. 3 is a block diagram of a laundry material determining unit provided in the washing machine shown in FIG. 1;

FIG. 4 is a view showing a speed variation of a motor provided in the washing machine shown in FIG. 1;

FIG. 5 is a flowchart illustrating a method of determining the amount of the laundry;

FIG. 6 is a graph showing a relationship between the torque of the motor and the speed of the motor according to the embodiment of the present invention;

FIG. 7 is a graph showing a pattern of the number of rotations of the motor in a dehydrating process according to the embodiment of the present invention; and

FIG. 8 is a flowchart illustrating a method of determining a laundry material in the dehydrating process according to the embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

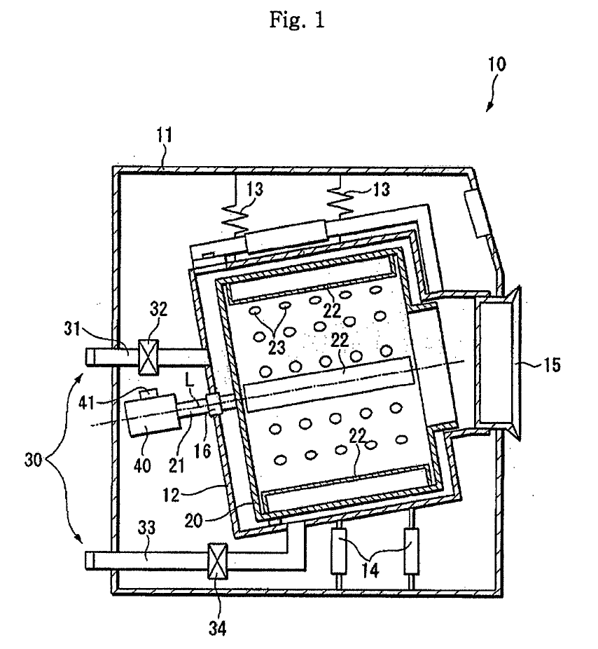

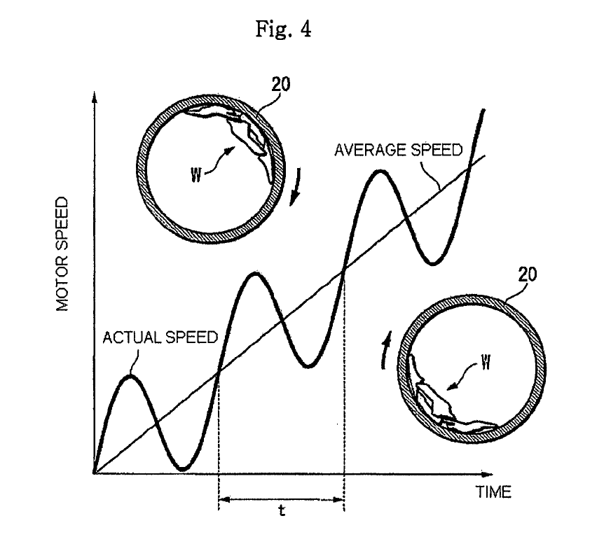

A washing machine according to the embodiment of the present invention is a drum-shaped washing machine 10 which can perform a washing and dehydrating process. As shown in FIGS. 1 to 3, the washing machine 10 includes a casing 11, a tub 12 suspended in the casing 10, a spin basket 20 (rotation body) rotatably installed in the tub 12, a supplying/discharging unit 30 for supplying/discharging water to/from the spin basket 20, a motor 40 which rotates the spin basket 20 about a rotation shaft L in a rotational direction, a laundry amount calculating unit 50 which calculates the weight, that is the amount, of laundry W (FIG. 4) put in the spin basket 20, and a dehydrating process control unit 60 which controls the rotation of the spin basket 20 in the dehydrating process.

The tub 12 has a bottom and is cylindrically shaped. A main shaft 21 of the tub 12 is sloped with respect to a horizontal plane to be positioned upward at the front side of the tub 12 (the right side of FIG. 1). The tub 12 is supported by a plurality of springs 13 and/or a damper 14 within the casing 11. An opening of the tub 12 is opened or closed by a door 15 provided on the front surface of the casing 11.

A bearing 16 rotatably supporting the main shaft 21 of the spin basket 20 is provided on the rear side of the tub 12 (the left side of FIG. 1).

The spin basket 20 provided in the tub 12 has a bottom and is cylindrically shaped. An opening is provided in the spin basket 20 toward the opening of the tub 12. The main shaft 21, which can rotate the spin basket 20 about the rotation shaft L in the rotational direction, is provided at the rear side of the spin basket 20 and is supported by the bearing 16 of the tub 12. Accordingly, the rotation shaft L of the spin basket 20 and the central shaft of the tub 12 are substantially equal to each other.

A plurality of lifters 22 protruded toward the inner circumferential side are provided on the inner circumferential surface of the spin basket 20 in the circumferential direction at the same interval. The lifters 22 lift the laundry W put therein according to the rotation of the spin basket 20.

A plurality of holes 23 communicating the inside of the spin basket 20 with the tub 12 is formed in the spin basket 20. Water, which flows into the tub 12, flows into the spin basket 20 through the holes 23 during the washing process and water, which flows out of the laundry W, flows from the spin basket 20 into the tub 12 through the holes 23 during the dehydrating process.

The supplying/discharging unit 30 includes a supplying tube 31 supplying water into the tub 12, a supplying valve 32 provided on the supplying tube 31, a discharging tube 33 discharging water from the tub 12, and a discharging valve 34 provided on the discharging tube 33.

The supplying tube 31 connects the rear end of the tub 12 to a water pipe provided at the outside of the washing machine 10 and supplies water into the tub 12 to supply water into the spin basket 20 through the holes 23.

One end of the discharging tube 33 is connected to the lower part of the tub 12 such that water, which flows from the spin basket 20 into the tub 12 through the holes 23, is discharged to the outside of the washing machine.

The motor 40 is, for example, a DC motor rotating the main shaft 21 about the rotation shaft L in the rotational direction. The spin basket 20 rotates once per rotation of the motor 40.

The motor 40 includes a Hall IC sensor 41 measuring the rotation speed ω of the motor 40. The operation of the motor 40 is controlled by a motor rotation control unit 42.

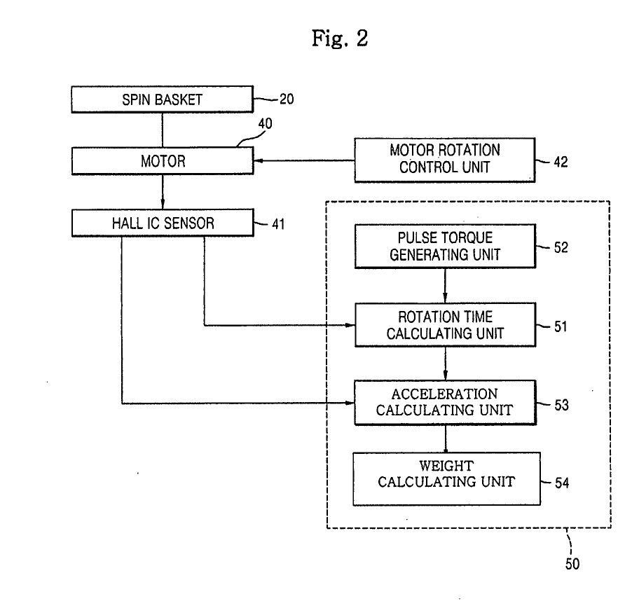

As shown in FIG. 2, the laundry amount calculating unit 50 includes a rotation time calculating unit 51 calculating a time period when the spin basket 20 rotates once, a pulse torque generating unit 52 supplying a predetermined voltage to the motor 40 during the time period t when the spin basket rotates once and generating a pulse torque through an output shaft from the motor 40, an acceleration measuring unit 53 measuring rotation acceleration of the output shaft of the motor 40 according to the pulse torque, and a weight calculating unit 54 calculating the weight of the laundry W put in the spin basket 20 using the rotation acceleration.

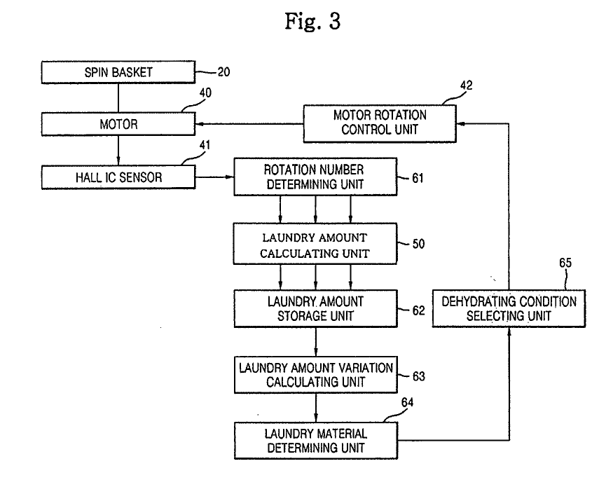

As shown in FIG. 3, the dehydrating process control unit 60 includes a rotation number determining unit 61 determining the number of rotations of the spin basket 20, the laundry amount calculating unit 50 calculating the amount of the laundry put in the inner space of the spin basket 20, a laundry amount storage unit 62 storing the amount of the laundry calculated by the laundry amount calculating unit 50, a laundry amount variation calculating unit 63 calculating a variation in laundry amount, a laundry material determining unit 64 determining the material of the laundry by the variation in laundry amount, and a dehydrating condition selecting unit 65 selecting an optimal dehydrating condition from a plurality of dehydrating conditions by the determined result of the laundry material determining unit 64.

Hereinafter, a washing method of the washing machine 10 having the above-described configuration will be described.

First, when the door 15 is opened, the laundry W is put into the spin basket 20, the door 15 is closed and a predetermined operation is selected using an operation panel, the laundry amount calculating unit 50 calculates the amount M of laundry in a dry state, the amount of water is determined according to the amount M of laundry, and a washing process begins.

In the washing process, water is supplied into the spin basket 20 through the supplying tube 31 by opening the supplying valve 32 and the supply of water stops by closing the supplying valve 32 at a time of reaching the amount of water according to the amount M of laundry. The motor 40 controlled by the motor rotation control unit 42 rotates the spin basket 20 about the rotation shaft L in the rotation direction. At this time, the lifters 22 lift the laundry W according to the rotation of the spin basket 20 and the lifted laundry W drops from the upper side of the spin basket 20 to collide with the lower side of the spin basket 20. Accordingly, the beating of the laundry W is performed efficiently. A cleaner is adequately supplied into the spin basket 20.

After the washing process is finished, a rinsing process is performed. In the rinsing process, the water contained in the spin basket 20 is discharged through the discharging tube 33 by opening the discharging valve 34 and then the discharging valve 34 is closed. Then, the spin basket 20 rotates in a state that water is supplied into the spin basket 20 through the supplying tube 31 and then the water contained in the spin basket 20 is discharged.

Subsequently, a dehydrating process of removing the water contained in the laundry W is performed. The spin basket 20 rotates about the rotation shaft L in the rotational direction at a high speed in a state that the water contained in the spin basket 20 is discharged through the discharging tube 33 by opening the discharging tube 34. Then, the water flows out of the laundry W by the centrifugal force generated by the rotation of the spin basket 20 and discharges to the outside of the spin basket 20 through the holes 23.

The washing of the laundry W is performed using the washing machine 10 by the above-described processes.

In the dehydrating process, when the laundry W put in the spin basket 20 is unevenly distributed and thus imbalance occurs, as shown in FIG. 4, the rotation speeds of the spin basket 20 and the motor 40 periodically vary by the position of the laundry W in the circumferential direction. That is, when the laundry W is positioned at the upper side of the spin basket 20, the force of gravity is added to the power of the motor 40 and thus the rotation speeds of the spin basket 20 and the motor 40 increase and, when the laundry W is positioned at the lower side of the spin basket 20, the force of gravity acts against the power of the motor 40 and thus the rotation speeds of the spin basket 20 and the motor 40 decrease.

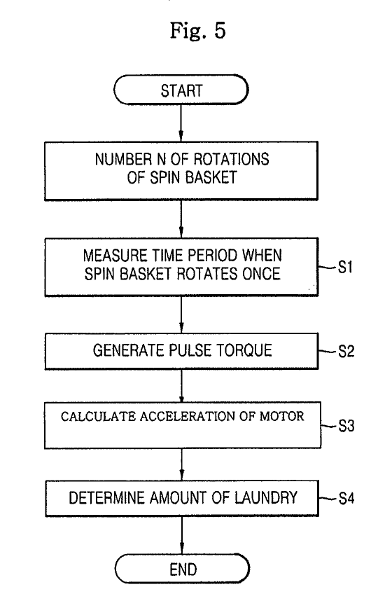

Subsequently, a method of calculating the amount of the laundry in the washing machine 10 having the above-described configuration will be described with reference to FIG. 5.

First, the motor 40 rotates the spin basket 20. Referring to FIG. 5, in this state, the rotation time calculating unit 51 calculates the time period t when the spin basket 20 rotates once by the signal outputted from the Hall IC sensor 41 measuring the rotation speed of the motor 40 (Operation S1).

The Hall IC sensor 41 of 12 pulses/rotation is used and the time period t when the motor 40 and the spin basket 20 rotate once can be calculated by counting 12 pulses.

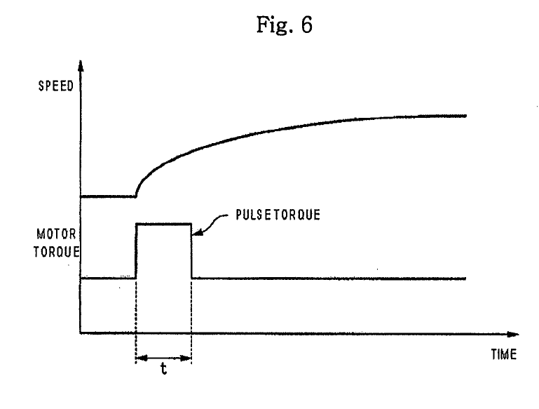

The pulse torque generating unit 52 supplies the predetermined voltage to the motor 40 during the time period t when the spin basket rotates once and generates the pulse torque through the output shaft from the motor 40 (Operation S2). At this time, the pulse torque is set to, for example, 50 rotations/sec or less such that large stress is not applied to the motor 40. As shown in FIG. 6, the motor 40 is accelerated in a step response manner by generating the pulse torque.

The acceleration calculating unit 53 calculates average rotation acceleration Aₐᵥₑ at the initial period of the acceleration during the time period t when the spin basket 20 rotates once (Operation S3). The average rotation acceleration Aₐᵥₑ is calculated using the following equation by measuring the time period Δt when the pulse signal of the Hall IC sensor 41 is counted during the time period t when the spin basket rotates once.

Aₐᵥₑ=1/(Δt)²

In the present invention, the time period is measured by counting the pulse signal of the Hall IC sensor 41 to 12 pulses.

The weight calculating unit 54 obtains the moment of inertia of the spin basket 20 from the average rotation acceleration Aₐᵥₑ and calculates the weight (amount) using the second law of motion (torque=moment of inertia×acceleration) (Operation S4). The weight of the laundry is calculated from the moment of inertia and the radius of the basket known by the formula (moment of inertia=weight×square of radius).

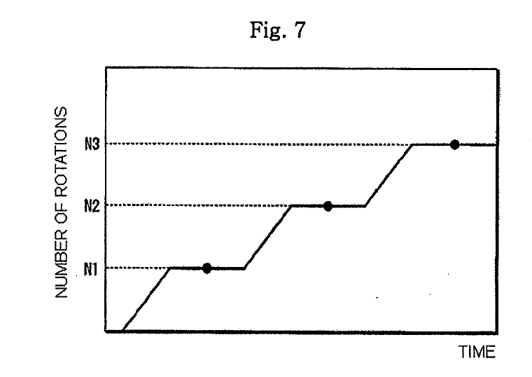

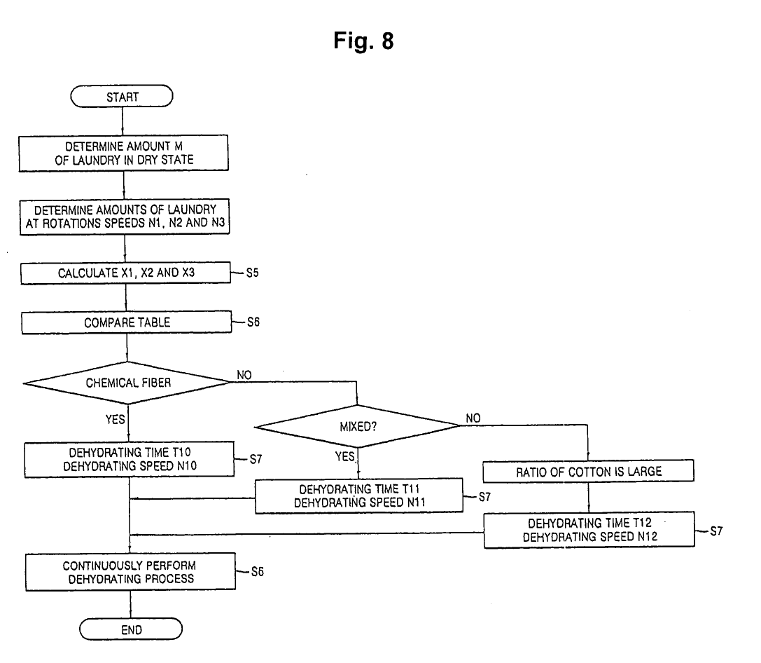

Subsequently, a method of determining the material of the laundry in the dehydrating process will be described with reference to FIGS. 3, 7 and 8.

The amount M of laundry, which is calculated in the dry state when the laundry W is put into the spin basket 20 and the door 15 is closed, is stored in the laundry amount storage unit 62.

In the dehydrating process, the number N of rotations of the spin basket 20 is set to N1, the rotation number determining unit 61 determines that the number of rotations is maintained at N1, and the laundry amount calculating unit 50 calculates the amount B1 of laundry. This amount B1 of laundry is stored in the laundry amount storage unit 62.

Subsequently, the number N of rotations of the spin basket 20 is set to N2, the rotation number determining unit 61 determines that the number of rotations is maintained at N2, and the laundry amount calculating unit 50 calculates the amount B2 of laundry. This amount B2 of laundry is stored in the laundry amount storage unit 62.

Subsequently, the number N of rotations of the spin basket 20 is set to N3, the rotation number determining unit 61 determines that the number of rotations is maintained at N3, and the laundry amount calculating unit 50 calculates the amount B3 of laundry. This amount B3 of laundry is stored in the laundry amount storage unit 62.

The laundry amount variation calculating unit 63 calculates variations X1, X2 and X3 in laundry amount by the following equations on the basis of above-described data (Operation S5).

X1=(B1−M)M×100

X2=(B1−B2)M×100

X3=(B2−B3)M×100

The variations in laundry amount occur due to a variation in amount of water contained in the laundry W. Accordingly, X1 indicates the amount of water contained in the laundry W and X2 and X3 indicate dehydrating ratios at that time.

The amount X1 of water contained in the laundry W and the dehydrating ratios X2 and X3 vary depending on the material of the laundry. For example, in a case of a chemical fiber, the amount X1 of water contained in the laundry W is small and, in a case of cotton, the amount X1 of water contained in the laundry is large. The laundry material determining unit 64 determines the material of the laundry on the basis of the amount X1 of water contained in the laundry W and the dehydrating ratios X2 and X3 according to a comparison table (Operation S6).

The dehydrating condition selecting unit 65 selects a dehydrating time and a dehydrating speed by the determined result (Operation S7) and then the dehydrating process is continuously performed. Specifically, the times and speeds of dehydration are set according to the chemical fiber, whether the fiber is mixed, and the ratio of cotton.

In the washing machine 10, the rotation time calculating unit 51 calculates the time period t when the spin basket 20 rotates once, the pulse torque generating unit 52 supplies the predetermined voltage to the motor 40 during the time period t when the spin basket 20 rotates once and generates the pulse torque through the output shaft from the motor 40, the acceleration calculating unit 53 calculates the initial average rotation acceleration Aₐᵥₑ of the output shaft of the motor 40 according to the pulse torque, and the weight calculating unit 54 calculates the weight using the acceleration data. Accordingly, the amount of the laundry can be calculated in a significantly short time.

Therefore, the amount of the laundry can be accurately calculated without physical influences, such as windage upon high-speed rotation, frictional resistance of a bearing, contact friction of laundry and mechanical vibrations, and electrical influence such as a rotation speed detecting error and a variation in power supply voltage.

As shown in FIG. 4, since the period of the speed variation when imbalance occurs in the spin basket 20 is equal to the time period t when the spin basket rotates once, the imbalance does not have influence on the calculation of the amount of the laundry although the acceleration is measured in a short time.

Since the amount of the laundry can be determined in a significantly short time, the amount of the laundry can be adequately determined with a predetermined number rotations of the spin basket 20. For example, the entrance and exit of the laundry W during the process can be detected or the dehydrating state in the dehydrating process can be checked.

In the embodiment of the present invention, since the laundry amount calculating unit 63 calculating the variation of laundry amount in the dehydrating process, the laundry material determining unit 64 determining the material of the laundry through the variation in laundry amount and the dehydrating condition selecting unit 65 selecting the dehydrating conditions according to the material of the laundry are included, the dehydrating conditions (the dehydrating time and the dehydrating speed) can be automatically set according to the material of the laundry.

Although the washing machine is described in the present invention, the present invention is not limited to this embodiment and may be adequately changed without departing from the scope of the present invention.

Although the Hall IC sensor of 12 pulses/rotation is used and the time period t when the spin basket rotates once is calculated, a high-precision Hall IC sensor may be used. Since the time period when the spin basket (motor) rotates once is calculated and is not influenced by a deviation in the pulse number, the amount of the laundry can be accurately measured although an inexpensive Hall IC sensor of 12 pulses/rotation is used.

The determination of the amount of the laundry may be performed in a process other than the dehydrating process. Accordingly, as described above, the amount of the laundry may be determined in the dry state to determine the amount of water or to estimate the imbalance amount.

As described above, according to the washing machine and the method of calculating the amount of the laundry of the embodiment of the present invention, it is possible to accurately measure the amount of the laundry put in the inner space of the spin basket in a significantly short time.

Although an embodiment has been shown and described, it would be appreciated by those skilled in the art that changes may be made in this embodiment without departing from the principles and spirit of the invention, the scope of which is defined in the claims and their equivalents.

What is claimed is:

1. A washing machine comprising:
a rotation shaft comprising an output shaft;
a motor;
a spin basket which has an inner space to put laundry therein and is rotated about the rotation shaft in a rotational direction by driving the motor;
a rotation time calculating unit which calculates a time period for the spin basket to rotate once;
a pulse torque generating unit which supplies a predetermined current or voltage to the motor during the time period for the spin basket to rotate once and generates a pulse torque through the output shaft of the motor;
an acceleration calculating unit which calculates rotation acceleration of the output shaft of the motor according to the pulse torque generated from the motor; and
a weight calculating unit which calculates the weight of the laundry put in the inner space of the spin basket by the calculated rotation acceleration.

2. The washing machine according to claim 1, further comprising:
a weight variation calculating unit which performs, in plural, a series of processes which are performed by the rotation time calculating unit, the pulse torque generating unit, the acceleration calculating unit and the weight calculating unit and calculates a variation in weight of the laundry, in a dehydrating process; and
a laundry material determining unit which determines a material of the laundry according to the calculated variation in laundry weight; and
a condition selection unit which selects an optimal dehydrating condition from a plurality of dehydrating conditions according to the determined material of the laundry.

3. A method of calculating an amount of laundry in a washing machine including a spin basket which has an inner space for putting laundry therein and is rotated mounted about a rotation shaft in a rotational direction by driving a motor, the method comprising:
calculating a time period for the spin basket to rotate once;
supplying a predetermined current or voltage to the motor during the time period for the spin basket to rotate once and generating a pulse torque through an output shaft from the motor;
measuring a rotation acceleration of the output shaft of the motor according to the pulse torque generated from the motor; and
calculating a weight of the laundry put in the inner space of the spin basket by the rotation basket.

4. The method according to claim 3, further comprising:
performing the calculating of the time period, the supplying of the predetermined current or voltage, the measuring of the rotation acceleration and the calculating each of the weight of the laundry in plural, in a dehydrating process;
calculating a variation in the laundry weight of the laundry;
determining a material of the laundry according to the calculated variation in laundry weight; and
selecting an optimal dehydrating condition from a plurality of dehydrating conditions according to the determined material of the laundry.

5. The washing machine according to claim 1, wherein said acceleration calculating unit calculates the initial period of acceleration during the time period when the spin basket rotates.

6. The washing machine according to claim 1, wherein said acceleration calculating unit calculates an initial period of acceleration during the time period for the spin basket to rotate once.

7. The washing machine according to claim 2, wherein said acceleration calculating unit calculates an initial period of acceleration during the time period for the spin basket to rotate once.

8. The washing machine according to claim 2, wherein said laundry material determining unit determines the material of the laundry on the basis of an amount of water contained in the laundry and the dehydrating ratios.

9. A method comprising:
calculating a time for a spin basket of a washing machine to rotate once;
calculating a rotational acceleration of the spin basket during the time for the spin basket to rotate once; and
calculating a weight of laundry put in the spin basket according to the calculated rotational acceleration.
